(19) United States
(12) Patent Application Publication
(10) Pub. No.: US 2025/0228718 A1
(43) Pub. Date: Jul. 17, 2025

(54) Patient Transport Apparatus Having A Cable Assembly

(71) Applicant: Stryker Corporation, Portage, MI (US)

(72) Inventors: Ryan Ludemann, Kalamazoo, MI (US); Michael Maurice Desjardins, Plainwell, MI (US); Mackenzie Van Loon, Mattawan, MI (US)

(73) Assignee: Stryker Corporation, Portage, MI (US)

(21) Appl. No.: 18/975,306

(22) Filed: Dec. 10, 2024

Related U.S. Application Data
(60) Provisional application No. 63/621,637, filed on Jan. 17, 2024.

(51) Int. Cl. A61G 1/056; A61G 1/013; A61G 1/02; A61G 3/02; A61G 7/10

(52) U.S. Cl. CPC A61G 1/0567; A61G 1/013; A61G 3/0236; A61G 3/0245; A61G 3/0254; A61G 7/1019; A61G 1/0256; A61G 1/0262

(57) ABSTRACT

A patient transport apparatus including a base, a litter, a lift mechanism, a litter extension and a cable assembly. The lift mechanism is interposed between the base and the litter and includes an actuator for moving the litter relative to the base. The litter extension moves relative to a patient support surface of the litter between a plurality of litter extension positions. The cable assembly includes a cable and a cable housing. The cable translates mechanical force applied to a user interface of the letter extension to the actuator. The cable housing is operatively attached to the litter and defines an inner cavity, a guide disposed within the inner cavity. The cable housing retains at least a portion of the cable as the litter extension moves between the plurality of litter extension positions.

### CROSS-REFERENCE TO RELATED APPLICATION

The subject patent application claims priority to and all the benefits of U.S. Provisional Patent Application No. 63/621,637 filed on Jan. 17, 2024, the disclosure of which is hereby incorporated by reference in its entirety.

### BACKGROUND

Patient support systems facilitate care of patients in a health care setting. Patient support systems comprise patient transport apparatuses such as, for example, hospital beds, stretchers, cots, tables, wheelchairs, and chairs. A conventional patient transport apparatus generally includes a base and a litter upon which the patient is supported via one or more deck sections.

Often, patient transport apparatuses have one or more user interfaces to perform one or more functions on the patient support apparatus. These functions can include lifting and lowering the litter or the base, moving a patient forward and backward, raising a patient from a horizontal position to an inclined position, or vice versa, and the like. Additionally, these functions can include extending out a portion of the patient transport apparatus to accommodate a body of the patient. In order to perform these functions, a mechanism must connect the user interface to an actuator. These functions are advantageous in situations where patient transport apparatuses are loaded and unloaded into emergency response vehicles. This connection mechanism can be wired, for example a cable, or wireless electronic communications. In situations where the connection is a cable, the cable can be a varying length depending on the function of the patient support apparatus. However, in some situations, an engaging arm of the emergency response vehicle can interfere with the connection mechanism connecting the user interface to the actuator upon loading and unloading the patient transport apparatus causing damage to the connection.

A patient transport apparatus designed to prevent interference of an engaging arm with a connection mechanism is desired.

### SUMMARY

The present disclosure provides patient transport apparatus including a base, a litter, a lift mechanism, a litter extension and a cable assembly. The litter defines a patient support surface to support a patient. The lift mechanism is interposed between the base and the litter. The lift mechanism includes an actuator for moving the litter relative to the base between a plurality of vertical configurations including a lowered configuration and a raised configuration. The litter extension is supported for movement relative to the patient support surface between a plurality of litter extension positions including a retracted position and one or more extended positions. The litter extension supports a user interface for operating the actuator of the lift mechanism. The cable assembly includes a cable and a cable housing. The cable translates mechanical force applied to the user interface to the actuator to release the lift mechanism for movement between the raised configuration and the lowered configuration. The cable extends between a first end coupled to the user interface and a second end coupled to the actuator of the lift mechanism. The cable housing is operatively attached to the litter. The cable housing defines an inner cavity and a guide disposed within the inner cavity. The cable housing supports the cable between the first end and the second end to retain at least a portion of the cable between the first end and the second end as the litter extension moves between the plurality of litter extension positions.

The present disclosure also provides a system for use in removably loading a patient transport apparatus into an emergency vehicle. The system includes a loading and unloading system for attaching to the emergency vehicle and a patient transport apparatus. The loading and unloading system include a track for mounting to the emergency vehicle and a trolley. The trolley is slidably mounted to the tracks. The patient transport apparatus is configured for releasable attachment to the loading and unloading system. The patient transport apparatus including a base, a litter, a lift mechanism, a litter extension and a cable assembly. The litter defines a patient support surface to support a patient. The lift mechanism is interposed between the base and the litter. The lift mechanism includes an actuator for moving the litter relative to the base between a plurality of vertical configurations including a lowered configuration and a raised configuration. The litter extension is supported for movement relative to the patient support surface between a plurality of litter extension positions including a retracted position and one or more extended positions. The litter extension supports a user interface for operating the actuator of the lift mechanism. The cable assembly includes a cable and a cable housing. The cable translated mechanical force applied to the user interface to the actuator to release the lift mechanism for movement between the raised configuration and the lowered configuration. The cable extends between a first end coupled to the user interface and a second end coupled to the actuator of the lift mechanism. The cable housing is operatively attached to the litter. The cable housing defines an inner cavity and a guide disposed within the inner cavity. The cable housing supports the cable between the first end and the second end to retain at least a portion of the cable between the first end and the second end as the litter extension moves between the plurality of litter extension positions.

### BRIEF DESCRIPTION OF THE DRAWINGS

Advantages of the present disclosure will be readily appreciated as the same becomes better understood by reference to the following detailed description when considered in connection with the accompanying drawings, wherein:

FIG. 1 is a perspective view of a patient transport apparatus including a litter extension assembly in a retracted configuration, according to the teachings of the present disclosure;

FIG. 2 is a perspective view of a patient transport apparatus including a litter extension assembly in an extended configuration, according to the teachings of the present disclosure;

FIG. 3 is a side view of the patient transport apparatus of FIG. 1 in a raised configuration, according to the teachings of the present disclosure;

FIG. 4 is a side view of the patient transport apparatus of FIG. 1 in a lowered configuration, according to the teachings of the present disclosure;

FIG. 5 is a perspective view of a cable assembly, including an actuator and the litter extension in the retracted configuration, according to the teachings of the present disclosure;

FIG. 6 is a perspective view of the cable assembly of FIG. 5, including the actuator and the litter extension in the extended configuration, according to the teachings of the present disclosure;

FIG. 7A is a top perspective view of a cable housing, according to the teachings of the present disclosure;

FIG. 7B is a bottom perspective view of the cable housing of FIG. 7A, according to the teachings of the present disclosure;

FIG. 8 is a top perspective view of an upper portion of the cable housing of FIG. 7A, according to the teachings of the present disclosure;

FIG. 9 is a top perspective view of a lower portion of the cable housing of FIG. 7A, according to the teachings of the present disclosure;

FIG. 10 is a side view of an emergency vehicle with a loading and unloading system for attaching the patient transport apparatus of FIG. 1 in a released and deployed configuration, according to the teachings of the present disclosure;

FIG. 11 is a side view of an emergency vehicle with a loading and unloading system for attaching the patient transport apparatus of FIG. 1 in an engaged and deployed configuration, according to the teachings of the present disclosure; and

FIG. 12 is a side view of an emergency vehicle with a loading and unloading system for attaching the patient transport apparatus of FIG. 1 in an engaged and received configuration, according to the teachings of the present disclosure.

### DETAILED DESCRIPTION

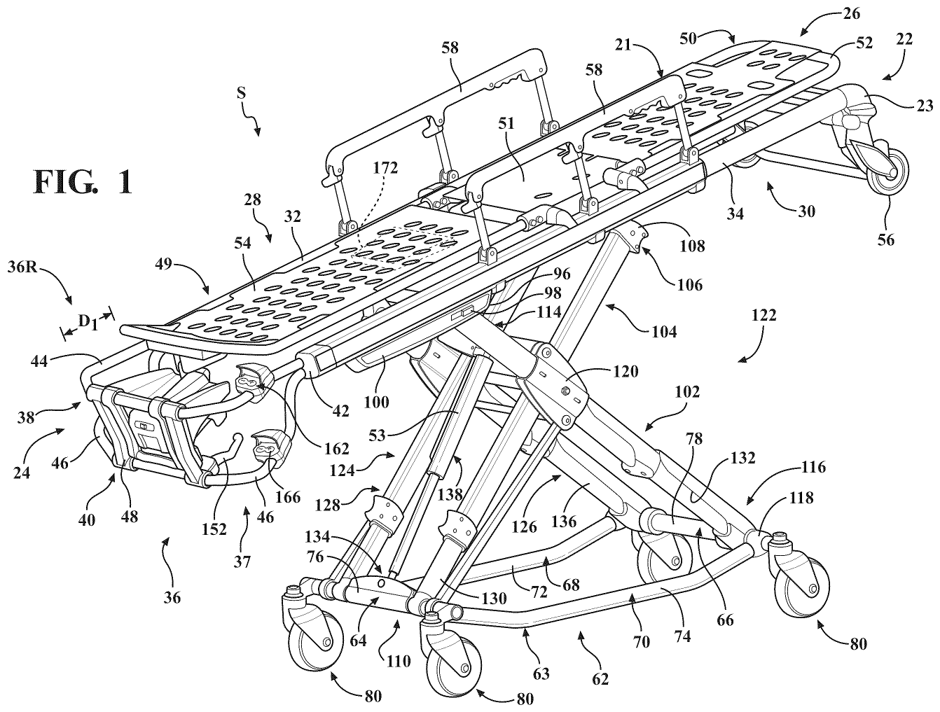

Referring to FIGS. 1-4, a patient transport apparatus 20 of a system S for providing patient care is shown. More specifically, the patient transport apparatus 20 illustrated in FIGS. 1-4 is realized as a cot for supporting a patient in a health care and/or transportation setting. In other versions, however, the patient transport apparatus 20 may be realized as a hospital bed, stretcher, table, wheelchair, chair, or similar apparatus utilized in the transportation and care of a patient.

The patient transport apparatus 20 generally includes a support structure 21 with a litter 22 defining a patient support surface 50 to support a patient, and a base 62 arranged for movement along ground surfaces GS, as described in greater detail below. In some versions, the patient transport apparatus 20 may be similar to as is described in one or more of U.S. Pat. Nos. 10,987,268 and 10,987,260, the disclosures of each of which are hereby incorporated by reference in their entirety. Other configurations are contemplated.

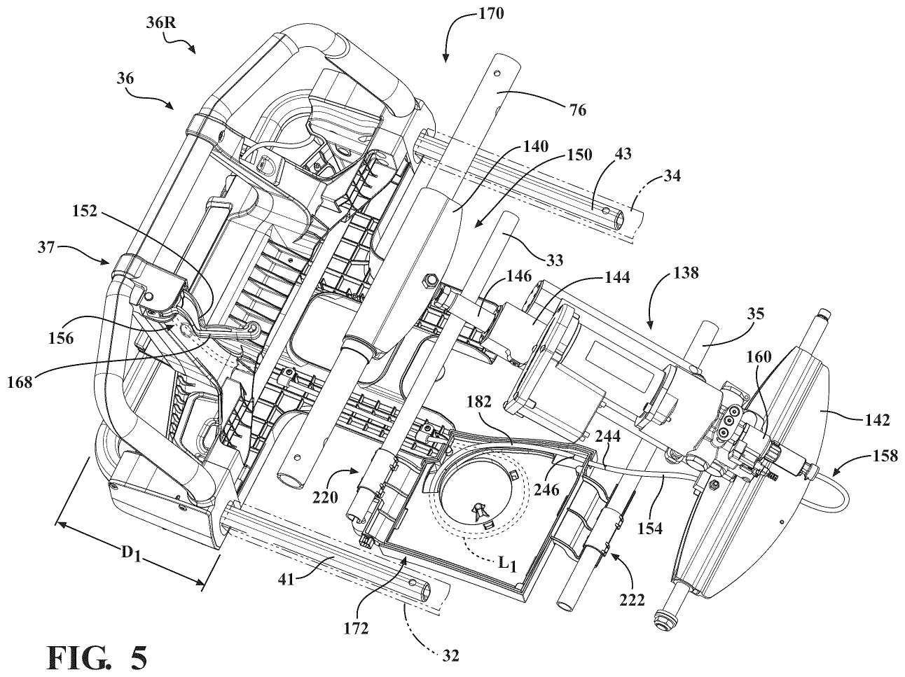

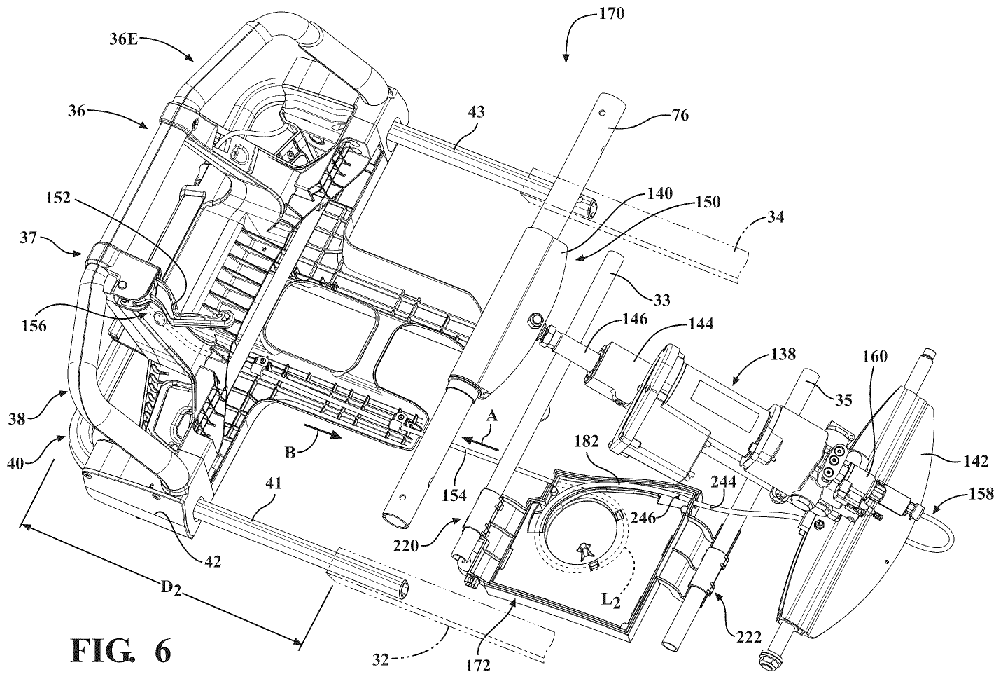

The support structure 21 may have various configurations and may include a variety of components. For example, the litter 22 may include a frame 23 (also referred to as an “intermediate frame” or “litter frame”) with two opposing lateral sides 24, 26 extending along the width coupled to a foot end side 28 and an opposing head end side 30 extending along the length. The frame 23 may have various configurations and may include a variety of components. As best shown FIG. 1, the frame 23 includes hollow side rails 32, 34 extending longitudinally between the end sides 28, 30. In the illustrated version, the frame 23 also includes first and second cross rails 33, 35 extending laterally between the side rails 32, 34 (see FIGS. 5-6).

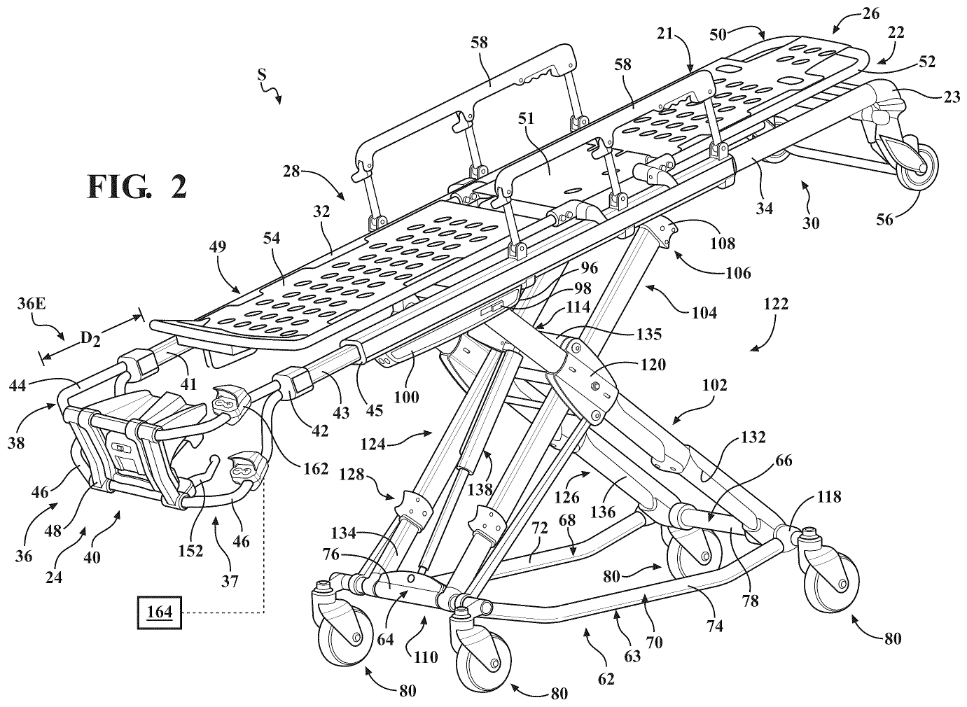

In the representative version illustrated herein, the patient transport apparatus 20 also includes a litter extension 36. In some versions, the litter extension 36 is arranged adjacent to the foot end side 28, as shown in FIGS. 1-4. However, it will be appreciated that the litter extension 36 may be arranged in other ways, such as adjacent to the head end side 30. In some versions, the litter extension 36 may extend from any side of the litter 22, including from one of the lateral sides 24, 26. In some versions, multiple litter extensions 36 may be employed, such as with one arranged adjacent to the foot end side 28, one arranged adjacent to the head end side 30, and the like. Other configurations are contemplated. The litter extension 36 is supported for movement relative to the patient support surface 50 (or other portions of the support structure 21) between a plurality of litter positions including a retracted position 36R (see FIGS. 1 and 5) and one or more extended positions 36E (see FIGS. 2 and 6). A user interface 37 is coupled to the litter extension 36 for concurrent movement between the litter positions 36E, 36R (compare FIGS. 1-2 and 5-6). As is described in greater detail below, the user interface 37 is configured to facilitate operation of one or more aspects of the patient transport apparatus 20 and/or other components of the system S.

In some versions, the litter extension 36 may include a pair of vertically spaced U-shaped frame members 38 and 40. The frame members 38, 40 may be joined together by frame brackets 42 (only one frame bracket 42 is shown in FIG. 1) and operatively attached to joined frame members 41, 43 (see: FIGS. 5-6), which may be telescopingly affixed inside side rails 32, 34 to facilitate movement between the litter positions 36E, 36R (compare FIGS. 1-2 and 5-6). As shown in FIGS. 5 and 6, the joined frame members 41, 43 are supported for movement into and out of the respective hollow side rails 32, 34 to extend an overall length of the litter 22. In the illustrated version, one or more components of the litter extension 36 are arranged at a first distance D1 relative to the hollow side rails 32, 34 in the retracted position 36R (see FIG. 1), and at a second distance D2 relative to the hollow side rails 32, 34 in the extended position 36E (see FIG. 2), wherein the first distance D1 is smaller than the second distance D2. In some versions, the frame members 38, 40 of the litter extension 36 may be arranged so as to define pairs of vertically spaced handling areas 44, 46 on frame members 38, 40, respectively. Here, spacer brackets 48 may be connected to opposing portions of each of the frame members 38 and 40 to maintain vertical spacing between the handling areas 44 and 46.

The litter 22 may include or otherwise define various components or features which aid in supporting and/or transporting the patient. The litter 22 includes a patient support deck 49 operatively attached to the frame 23 and defining the patient support surface 50. In the representative version illustrated herein, the patient support deck 49 includes one or more deck sections, such as a seat section 51, a back section 52 (also referred to as a “fowler section”) and a leg section 54 to facilitate care and/or transportation of the patient in various patient positions. While not depicted in detail herein, additional deck sections may be employed in some versions, such as with discrete leg and foot sections articulable relative to each other and to the frame 23 to facilitate supporting the patient in other positions, such as in a gatch position (not shown). Other configurations are contemplated.

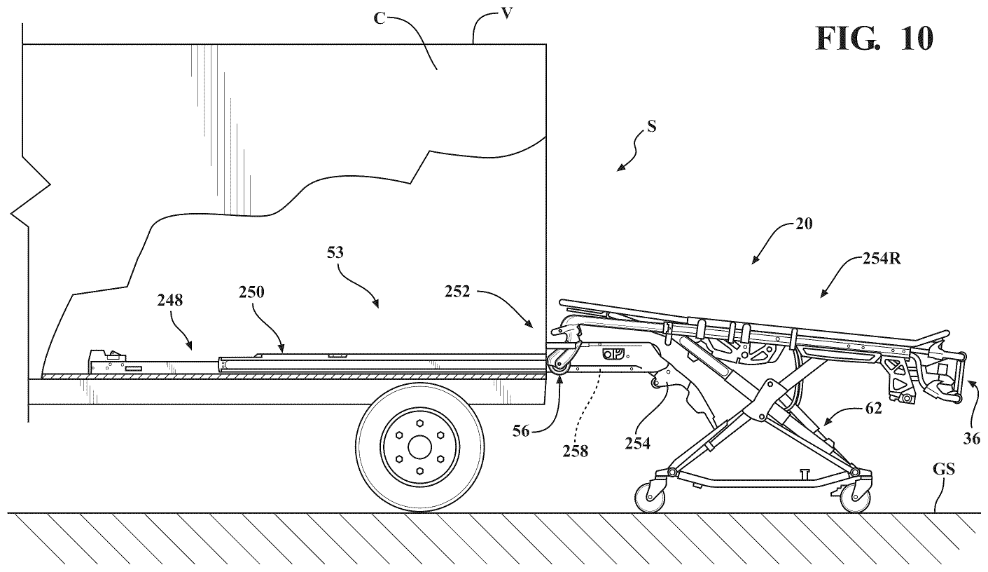

The litter 22 may also be coupled to loading wheels 56. As shown in FIG. 1, the loading wheels 56 may extend from the frame 23 proximal to the back section 52 of the patient support surface 50 and may facilitate loading and unloading of the patient transport apparatus 20 from a vehicle V. In some versions, the loading wheels 56 may be positioned and configured to facilitate loading and unloading the patient transport apparatus 20 manually into an emergency response vehicle V. As is described in greater detail below in connection with FIGS. 10-12, the system S may also include a loading and unloading system 53 configured to removably secure the patient transport apparatus 20 to the emergency response vehicle V.

The litter 22 may also include hand rails 58. In FIG. 1, the hand rails 58 are shown extending from opposing lateral sides of the frame 23 and provide egress barriers for the patient on the patient support surface 50. The hand rails 58 may also be utilized by an individual, such as a caregiver, an emergency medical technician (EMT), or another medical professional, to move or manipulate the patient transport apparatus 20. In some versions, the hand rails 58 may include a hinge, pivot, or similar mechanism to allow the hand rails 58 to be folded or stored adjacent to or below the patient support surface 50.

As noted above, the support structure 21 of the patient transport apparatus 20 also includes the base 62, which is arranged for movement along ground surfaces GS. In the illustrated version, the base 62 employs a base frame 63 which includes two opposing lateral base sides 64, 66 extending along the width which are coupled to two opposing longitudinal base sides 68, 70 extending along the length. As shown in FIG. 1, the longitudinal base sides 68, 70 may include longitudinally-extending rails 72, 74 and the lateral base sides 64, 66 may include crosswise-extending rails 76, 78 which may be coupled at the ends thereof to the rails 72, 74. While the base frame 63 of the illustrated version of the base 62 has a generally rectangular profile, it will be appreciated that other configurations are contemplated, including versions where the base 62 is configured without a discrete base frame 63.

In order to facilitate movement along ground surfaces GS, the representative version of the base 62 includes a plurality of caster wheel assemblies 80 operatively connected adjacent to each corner of the base frame 63 defined by the longitudinally-extending rails 72, 74 and the crosswise-extending rails 76, 78. As such, the patient transport apparatus 20 of FIG. 1 may include four caster wheel assemblies 80. The wheel assemblies 80 may be configured to swivel to facilitate turning of the patient transport apparatus 20. The wheel assemblies 80 may include a swivel locking mechanism to prevent the wheel assemblies 80 from swiveling when engaged. The wheel assemblies 80 may also include wheel brakes 82 to prevent rotation of the wheel. While the base frame 63 of the illustrated version of the base 62 has a generally rectangular profile, it will be appreciated that other configurations are contemplated, including versions where the base 62 is configured without a discrete base frame 63.

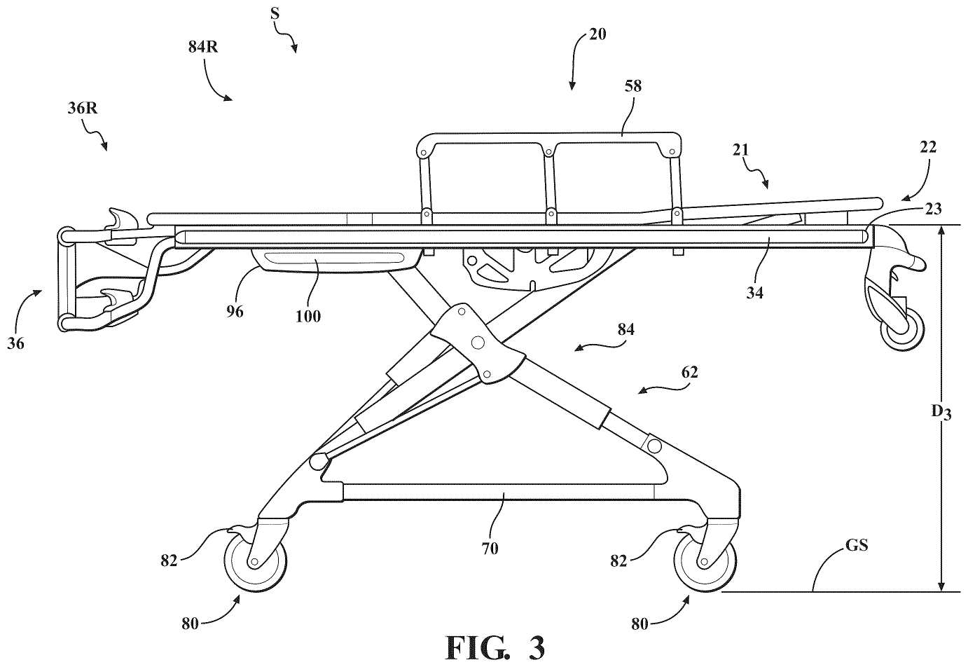

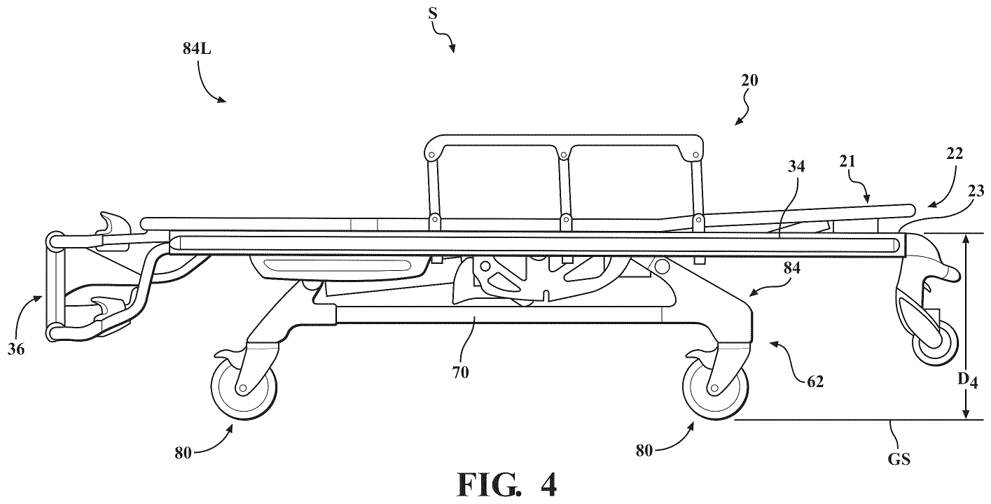

The patient transport apparatus 20 also includes a lift mechanism 84 interposed between the base 62 and the litter 22. The lift mechanism 84 is configured to move the litter 22 relative to the base 62 between a plurality of vertical configurations including a raised configuration 84R (see FIG. 3) and a lowered configuration 84L (see FIG. 4). Also shown in FIGS. 3 and 4, the raised configuration 84R and the lowered configuration 84L are defined by a raised distance D3 and a lowered distance D4 relative to the ground surface GS, with the raised distance D3 being larger than the lowered distance D4. It will be appreciated that raised distance D3 and the lowered distance D4 are illustrative examples of various different distances achievable between the base 62 and the litter 22 so as to define the raised and lowered configurations 84R, 84L, and that the lift mechanism 84 is configured to support the litter 22 for movement between a number of different configurations between a maximum lowered configuration and a maximum raised configuration (not shown in detail). In some versions, the lift mechanism 84 or other components of the patient transport apparatus 20 may be similar to as is described in one or more of U.S. Pat. Nos. 10,987,268 and 10,987,260, previously referenced. Other configurations are contemplated.

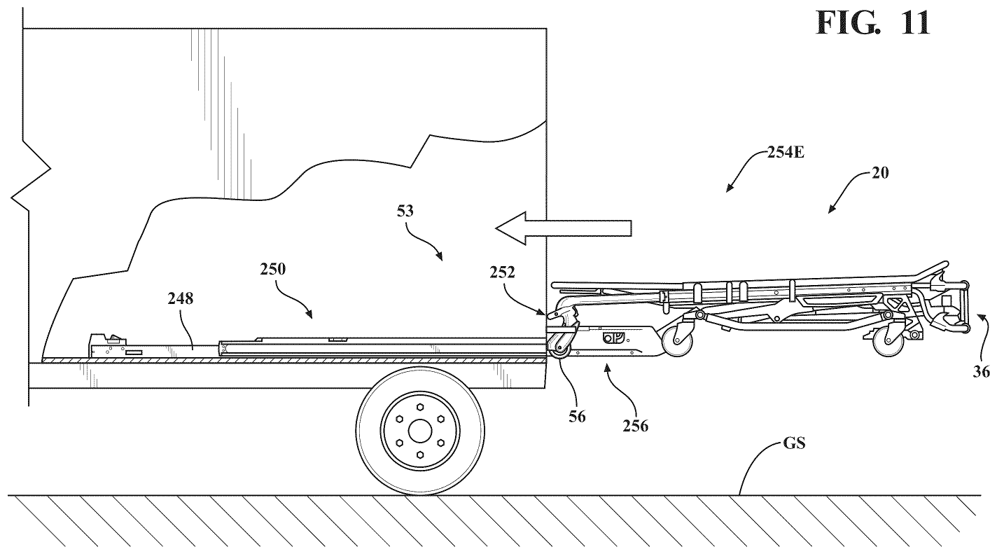

While moving between the plurality of vertical configurations 84R, 84L, the lift mechanism 84 may move either the base 62 or the litter 22 relative to the other of the litter 22 or the base 62 depending on how the patient transport apparatus 20 is supported during use. For instance, in FIGS. 3-4, the patient transport apparatus 20 is supported by the base 62 resting on the ground surface GS. In other instances, the patient transport apparatus 20 may be supported at the litter 22, such as during loading or unloading into the emergency response vehicle V (see FIG. 11). In instances where the patient transport apparatus 20 is supported at the litter 22, the lift mechanism 84, while moving between the plurality of vertical configurations, moves the base 62 relative to the litter 22. In instances where the patient transport apparatus 20 is supported at the base 62, the lift mechanism 84, while moving between the plurality of vertical configurations, moves the litter 22 relative to the base 62.

The patient transport apparatus 20 may include a variety of components that allow the lift mechanism 84 to move between the plurality of vertical configurations. For example, in the version depicted in FIGS. 1-4, the patient transport apparatus 20 includes a bracket 96 and a slidable member 98 disposed within a channel 100 of the bracket 96 and being moveable between a plurality of different positions in the channel 100. The bracket 96 may be coupled to a variety of locations on the patient transport apparatus 20. For example, the bracket 96 may be coupled to the frame 23. More specifically, in the illustrated version, the bracket 96 is coupled to an underside of the side rail 34 of side 30 of the frame 23. In other versions, however, the bracket 96 may be coupled to a different location on the patient transport apparatus 20. For instance, the bracket 96 may be coupled to a side of the side rail 34 which is closest to side 28. In another example, the bracket 96 may be coupled to the patient support surface 50. Furthermore, while a single bracket 96 is shown as being coupled to side 30 of the frame 23 in FIGS. 1-4, another bracket 96 may be coupled to side 28 of the frame 23. For example, another bracket 96 may also be coupled to an underside of the side rail 32 of side 28 of the frame 23.

The channel 100 may have various configurations and shapes, e.g., straight, zig-zag, S-shaped, curved, diagonal/sloped, or any combination thereof. For example, the channel 100 may have a linear shape. In other versions, the channel 100 may have a non-linear shape, a piecewise shape, a curvilinear shape, or any combination of linear or non-linear shapes. The bracket 96 and the channel 100 can be like that shown in one or more of U.S. Pat. Nos. 10,987,268 and 10,987,260, previously referenced. Other configurations are contemplated. As the slidable member 98 moves between the plurality of different positions within the channel 100, the lift mechanism 84 moves between the plurality of vertical configurations. In this way, each position of the slidable member 98 in the channel 100 corresponds to a vertical configuration of the lift mechanism 84. For example, in the raised configuration 84R depicted in FIG. 3, the slidable member 98 may be positioned near a first end of the channel 100, whereas in the lowered configuration 84L depicted FIG. 4, the slidable member 98 may be positioned closer to a second end of the channel 100. The slidable member 98, channel 100, and/or other portions of the lift mechanism 84 may be similar to as is described in one or more of U.S. Pat. Nos. 10,987,268 and 10,987,260, previously referenced. Other configurations are contemplated.

In the representative version depicted herein, the lift mechanism 84 includes a first frame member 102 and a second frame member 104, both of which are coupled to the litter 22 and the base 62. A first end 106 of the second frame member 104 may be pivotally coupled to the head-end of the frame 23 at a connection point 108 such that the second frame member 104 may pivot about the connection point 108. A second end 110 of the second frame member 104 may be pivotally coupled to a foot-end of the base frame 63 at a connection point 112 (not shown) such that the second frame member 104 may pivot about the connection point 112. Furthermore, a first end 114 of the first frame member 102 may be pivotally coupled to a foot-end of the frame 23 via the slidable member 98. More specifically, and as shown in FIG. 1, the first end 114 may be pivotally coupled to the slidable member 98, which is disposed in the channel 100 of the bracket 96, which is coupled to the frame 23. Accordingly, the first frame member 102 is pivotally coupled to the frame 23 and may pivot about the slidable member 98. Also shown, a second end 116 of the first frame member 102 may be pivotally coupled to a head-end of the base frame 63 at a connection point 118 such that the first frame member 102 may pivot about the connection point 118. Furthermore, the first frame member 102 and the second frame member 104 may be pivotally coupled to each other at the pivot axle 120 to form an “X” frame 122.

The lift mechanism 84 may include a second, similarly constructed X frame 124, which may include a third frame member 126 and a fourth frame member 128. Similar to X frame 122, the third frame member 126 and the fourth frame member 128 of X frame 124 may be pivotally coupled to a side of the frame 23 and a side of the base frame 63. For example, the third frame member 126 and the fourth frame member 128 of X frame 124 may be pivotally coupled to a side of the frame 23 and a side of the base frame 63, which oppose a side of the frame 23 and a side of the base frame 63 to which the first frame member 102 and the second frame member 104 are coupled. In the versions shown in FIG. 1, X frame 124 is coupled to one side 28 of the frame 23 and to one side 68 of the base frame 63, and X frame 122 is coupled to the other side 30 of the frame 23 and to the other side 70 of the base frame 63. It will be appreciated that any reference herein to the first frame member 102 may also be a reference to the third frame member 126. Similarly, any reference to the second frame member 104 may also be a reference to the fourth frame member 128.

In FIG. 1, the frame members 102, 104, 126, 128 are hollow and telescopingly include further frame members 130, 132, 134, 136, respectively. Further frame members 130, 132, 134, 136 are supported for movement into and out of the respective frame members 102, 104, 126, 128 to extend a length of the respective frame members 102, 104, 126, 128. In the version shown in FIG. 1, the further frame members 130, 132, 134, 136 extend out of frame members 102, 104, 126, 128 toward the base 62. However, in other examples, the further frame members 130, 132, 134, 136 may extend out of frame members 102, 104, 126, 128 toward the litter 22. In these examples, frame members 102, 104, 126, 128 are coupled to the base 62 or the litter 22 via further frame members 130, 132, 134, 136. However, in other examples, the frame members 102, 104, 126, 128 may be of a fixed length and exclude further frame members 130, 132, 134, 136. Additionally, while the lift mechanism 84 of the representative version illustrated in FIG. 1 includes four frame members 102, 104, 126, 128, the lift mechanism 84 may include any suitable number of frame members.

Those having ordinary skill in the art will appreciate that the lift mechanism 84 may move between the plurality of vertical configurations 84R, 84L in various ways depending, for example, on the specific configuration of the patient transport apparatus 20 and/or how a caregiver is using the patient transport apparatus 20. By way of illustrative example, in some versions the lift mechanism 84 may be configured for “manual” operation by one or more caregiver to facilitate adjusting the height of the litter 22 relative to the base 62, and in some versions the lift mechanism 84 may employ one or more actuators 138 to facilitate “powered” operation to adjust the height of the litter 22 relative to the base 62. It will be appreciated that the lift mechanism 84 of the patient transport apparatus 20 could employ any suitable number of actuators 138, which may be coupled to any suitable component of the support structure 21 and may be configured to move the lift mechanism 84 between the plurality of vertical configurations. As shown in FIG. 5, the illustrated actuator 138 is realized as a hydraulic linear actuator, which is connected to and extends between brackets 140 and 142. In this version, the actuator 138 includes a cylindrical housing 144 fastened to the bracket 142 and supporting a reciprocal rod 146 having a piston located within the cylindrical housing 144 (not shown in detail). The distal end of the reciprocal rod 146 is connected by a joint 150 to the bracket 140. The joint 150 allows pivotal movement about two orthogonally related axes. Extension and retraction of the reciprocal rod 146 will facilitate movement of the frame members 102, 126 of the lift mechanism 84 about the axis of the reciprocal rod 146. In some versions, the actuator 138 may not be the hydraulic linear actuator shown in FIGS. 5-6. The actuator 138 may be any actuator suitable for actuating the lift mechanism 84 such that the lift mechanism 84 moves between the plurality of vertical configurations. For example, the actuator 138 may be an electric motor, a servo motor, a pneumatic actuator, or any other suitable actuator. In some versions, the actuator 138 may be similar to as is described in U.S. Pat. No. 7,398,571, the disclosure of which is hereby incorporated by reference in its entirety. Furthermore, techniques for utilizing actuator 138 to manipulate the components of the patient transport apparatus 20 can be like those described in one or more of U.S. Pat. Nos. 10,987,268 and 10,987,260, previously referenced. Other configurations are contemplated.

As noted above, the patient transport apparatus 20 includes a user interface 37 supported for concurrent movement with the litter extension 36 between the retracted position 36R and the extended position 36E. The user interface 37 is arranged for selective user engagement to facilitate operation of the lift mechanism 84. While the user interface 37 could be configured in a number of different ways as described in greater detail below, in the representative versions illustrated herein, the user interface 37 includes a manual release element 152 which is disposed in force-translating relationship with the lift mechanism 84 via a cable 154. The cable 154 translates mechanical force applied to the manual release element 152 of the user interface 37 to the actuator 138 to release the lift mechanism 84 for movement between the raised configuration 84R and the lowered configuration 84L. In some versions, the cable 154 is realized as a Bowden cable which is at least partially flexible and is configured to transmit mechanical force or energy by the movement of an inner cable relative to a hollow outer cable housing or sheath (not shown in detail).

To this end, in the representative version illustrated herein, the cable 154 extends between a first end 156 coupled to the user interface 37, and a second end 158 coupled to the actuator 138 of the lift mechanism 84. In versions where the lift mechanism 84 is powered, such as via an electric motor which drives a pump (not shown in detail) to facilitate directing hydraulic fluid to the actuator 138, it will be appreciated that the use of the manual release element 152 affords users with the ability to manually adjust the height of the litter 22 relative to the base 62 (or vice-versa) without necessarily requiring the use of electricity to operate the electric motor driving the pump. While not illustrated in detail herein, it will be appreciated that the actuator 138 may be configured so as to allow hydraulic fluid to bypass or otherwise be routed so as to permit the rod 146 to move along the cylindrical housing 144 in response to applied force from the cable 154. Here, for example, the actuator 138 may include a valve release 160 to which the second end 158 of the cable 154 is coupled, whereby movement of the valve release 160 allows the rod 146 to move relative to the cylindrical housing 144. In some versions, operation of the hydraulic actuator 138 may be similar to as is described in one or more of U.S. Pat. Nos. 10,987,268 and 10,987,260, previously referenced. Other configurations are contemplated.

As noted above, different types and styles of actuators 138 and/or lift mechanisms 84 may be utilized by the patient transport apparatus 20 to facilitate releasing the lift mechanism 84 for movement between the raised configuration 84R and the lowered configuration 84L. By way of non-limiting example, the manual release element 152 may be utilized in connection with “manual” style lift mechanisms 84, which may employ actuators 138 which are realized as linkages or other mechanisms configured to maintain the litter 22 at specified heights relative to the base 62, whereby operation of the manual release element 152 could be configured to release these types of linkages (not shown) to facilitate movement between the raised configuration 84R and the lowered configuration 84L. Moreover, it will be appreciated that “powered” lift mechanisms 84 may likewise be realized in various ways, with different quantities, types, and/or arrangements of actuators 138.

In versions which employ “powered” lift mechanisms, it will be appreciated that the user interface 37 may include other modules to facilitate operation of the actuator 138. By way of non-limiting example, and as is depicted schematically in FIG. 1, the user interface 37 may include the manual release element 152 as well as one or more control panels 162 disposed in electrical communication with a controller 164 for operating the actuator 138 of the lift mechanism 84. As is depicted in FIGS. 1-2, in this version, both the manual release element 152 and the control panel 162 of the user interface 37 the litter extension 36 for concurrent movement between the litter positions 36E, 36R (see also FIGS. 5-6). In some versions, the control panel may include manually-engageable buttons 166, for example a lower button and a raise button. In some versions, the control panel 162 may be a touch screen. However, other configurations are contemplated, and the control panel 162 may include various types of input and/or output devices to communicate audible, visual, and/or tactile information.

In the representative versions illustrated herein, the manual release element 152 may be realized as a manually-engageable lever 168 that is pivotally secured to the to the litter extension 36 (e.g., to frame member 38 or frame member 40) and arranged for pivoting movement in response to user engagement to move the cable 154 an thereby release the lift mechanism 84 for movement between the raised configuration 84R and the lowered configuration 84L. However, other configurations are contemplated, and it will be appreciated that the manual release element 152 could be configured in other ways to facilitate applying force to the cable 154. For example, rather than the lever 168, a sliding mechanism (not shown) could be coupled to the cable 154.

Referring now to FIGS. 5-6, the cable 154 forms part of a cable assembly 170 of the patient transport apparatus 20 configured to facilitate operation of the lift mechanism 84 in response to user engagement with the manual release element 152 of the user interface 37 during operation of the litter extension 36 in and between the retracted position 36R (see FIG. 5) and the one or more extended positions 36E (see FIG. 6). In addition to the cable 154, the cable assembly 170 also includes a cable housing 172 operatively attached to the litter 22. The cable housing 172 defines an inner cavity 174 and a guide 176 disposed within the inner cavity 174. The guide 176 supports the cable 154 between the first end 156 and the second end 158 to retain at least a portion of the cable 154 between the first end 156 and the second end 158 as the litter extension 36 moves between the retracted position 36R (see FIG. 5) and the extended position 36E (see FIG. 6). The components of the cable assembly 170 introduced above will be described in greater detail below.

The cable 154 is routed from the user interface 37 to the actuator 138 through the cable housing 172. More specifically, the cable 154 is routed through the cable housing 172 through an inlet 178 and out of an outlet 180. The cable 154 defines a retained portion 182 disposed within the inner cavity 174 of the cable housing 172. The cable housing 172 accommodates and otherwise retains the retained portion 182 of the cable 154 within the inner cavity 174 between the inlet 178 and outlet 180 when moving between the extended position 36E and the retracted position 36R (compare FIGS. 5-6).

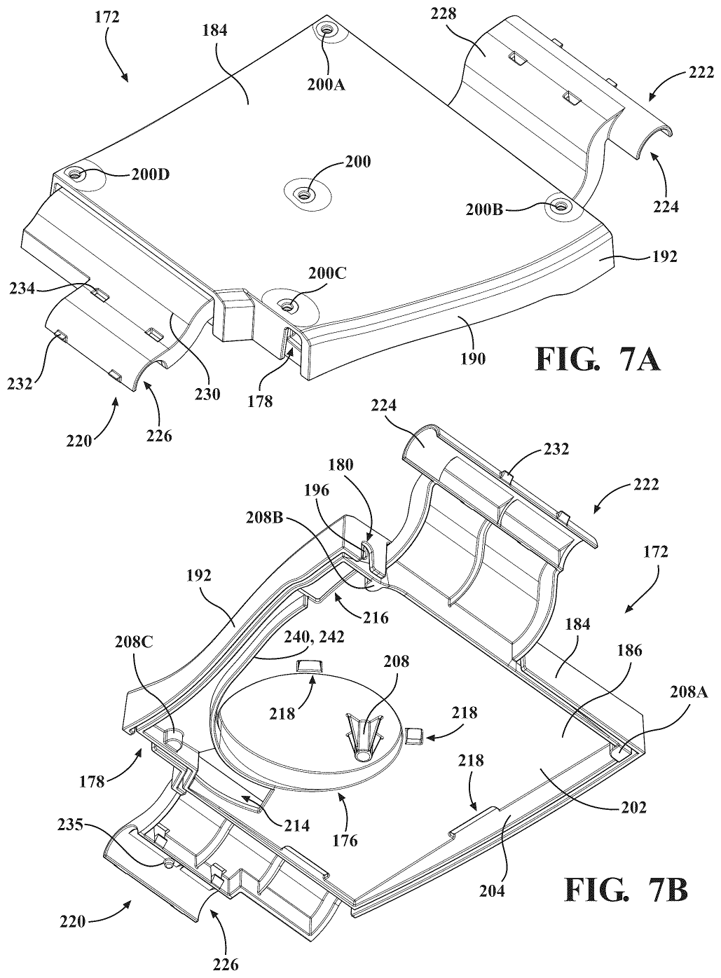

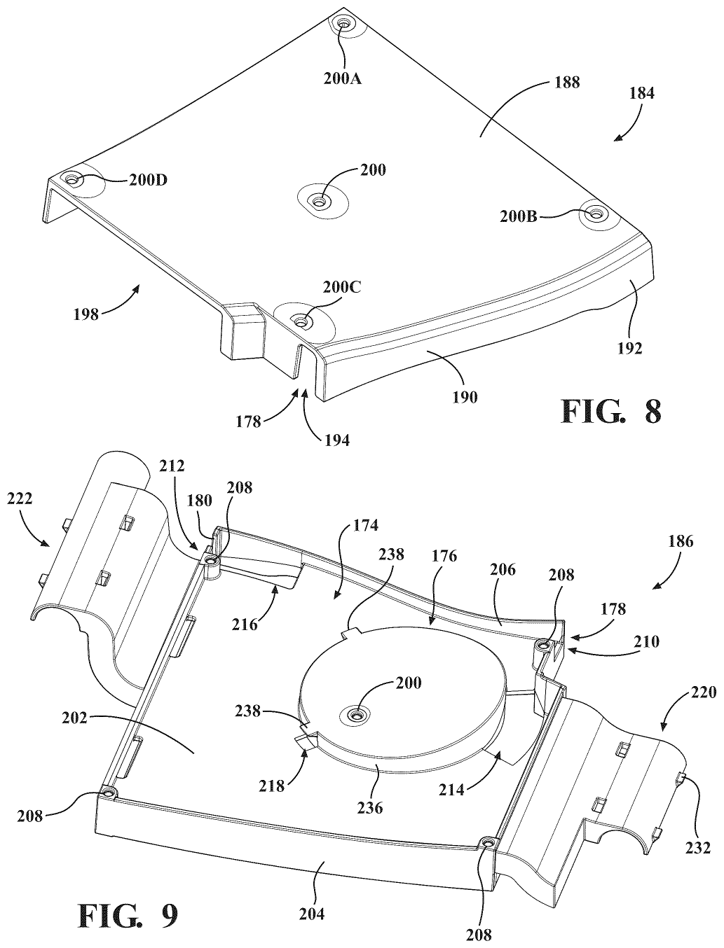

As shown in FIGS. 7A-9, the illustrated version of the cable housing 172 includes an upper portion 184 and a lower portion 186 operatively attached to the upper portion 184. As noted above, the cable housing 172 defines the inner cavity 174, the inlet 178, and the outlet 180. In some versions, the outlet 180 is positioned opposite the inner cavity 174 from the inlet 178 in a longitudinal direction. While representative version of the cable housing 172 illustrated herein is realized with the upper portion 184 and the lower portion 186 which cooperate to define the inner cavity 174, it will be appreciated that other configurations are contemplated, and the cable housing 172 may be formed as a unitary component or may be defined or otherwise formed by more than two components.

The upper portion 184 includes an upper wall 188 and a plurality of upper side walls 190 extending in a downward direction from the upper wall 188. The plurality of upper side walls 190 of the upper portion 184 the cable housing 172 further defines an outward face 192 facing away from the inner cavity 174, as well as an upper inlet 194, an upper outlet 196, and a coupling mechanism aperture 198. The upper wall 188 of the upper portion 184 includes or otherwise defines one or more securing apertures 200 to couple the upper portion 184 to the lower portion 186. However, it should be understood that the lower portion 186 may be coupled to the upper portion 184 through press fit, snaps, clips, adhesives, and the like. Other configurations are contemplated.

The lower portion 186 includes a lower wall 202 and a plurality of lower side walls 204 extending in an upward direction from the lower wall 202. The plurality of lower side walls 204 of lower portion 186 the cable housing 172 further define an inner face 206 facing towards the inner cavity 174. The lower wall 202 of the lower portion 186 includes securing cavities 208 to couple the upper portion 184 to the lower portion 186. The securing cavities 208 are arranged to engage the securing apertures 200 of the upper portion 184 to facilitate coupling the upper portion 184 and the lower portion 186 together, such as with fasteners (not shown).

In the illustrated version, the lower side walls 204 also include a lower inlet 210 and a lower outlet 212. Here, the lower inlet 210 and the upper inlet 194 cooperate to define the inlet 178, and the lower outlet 212 and the upper outlet 196 cooperate to define the outlet 180. The lower wall 202 includes or otherwise defines a guide aperture 214, an outlet aperture 216, and one or more face apertures 218. In some versions, one or more of the apertures 214, 216, 218 may define a drain aperture 214, 216, 218 arranged to permit a flow of fluids out of the inner cavity 174. In some versions, the lower wall 202 of the lower portion 186 slopes downward in a direction opposite the upper portion 184 to at least one of the plurality of drain apertures 214, 216, 218.

The lower portion 186 of the cable housing 172 includes a first coupling mechanism 220 and a second coupling mechanism 222 extending in an outward direction from the lower side walls 204 relative to the inner cavity 174. As shown in FIGS. 7A-9, the first coupling mechanism 220 has a generally curved profile and is positioned opposite the inner cavity 174 from the second coupling mechanism 222. The second coupling mechanism 222 has a generally curved profile. The first coupling mechanism 220 and the second coupling mechanism 222 each include a respective coupling portion 224, 226 operatively attached to a corresponding mount arm 228, 230 configured to encircle the first and second cross rails 33, 35 of the frame 23 of the litter 22 (see FIGS. 5-6). Here, the coupling portions 224, 226 of the coupling mechanisms 220, 222 operatively couple the cable housing 172 to the cross rails 33, 35. In some versions, one or more of the coupling mechanisms 220, 222 may include one or more snaps 232 and/or one or more snap apertures 234 arranged and configured to secure the coupling mechanism 220, 222 to the cross rails 33, 35. In some versions, this configuration may allow the cable housing 172 to remain secured to the cross rails 33, 35 while, at the same time, permitting a limited amount of sliding movement in the lateral direction along the cross rails 33, 35, which may help promote consistent routing and retention of slack in the cable 154 as the litter extension 36 moves between the retracted position 36R (see FIG. 5) and the extended position 36E (see FIG. 6). It will be appreciated that other configurations are contemplated, and the cable housing 172 of the cable assembly 170 could be secured to the frame 23 or to other portions of the support structure 21 of the patient transport apparatus 20 in a number of different ways. In some versions, one or more of the coupling portions 224, 226 may include a retention element 235 that is shaped and arranged to engage a portion of the cross rails 33, 35 or another portion of the patient transport apparatus 20 so as to at least partially restrict lateral movement of the cable housing 172. To this end, in the version depicted in FIG. 7B, one of the coupling portions 226 is shown as having a retention element 235 realized as a post that is shaped to engage a correspondingly-shaped aperture (not shown) formed in one of the cross rails 33, 35 to limit lateral movement of the cable housing 172 via the retention element 235. It will be appreciated that other configurations are contemplated, and different shapes, styles, types, and/or configurations of retention elements 235 (and/or the corresponding structure of the patient transport apparatus 20 to which they engage) may be utilized.

The lower portion 186 includes or otherwise defines the guide 176 in the illustrated versions, which is arranged extending into the inner cavity 174. Here, the guide 176 defines an outer surface 236 which, in the illustrated version, has a generally cylindrical or radial shape, it will be appreciated that other configurations are contemplated, and the guide 176 could have any shape or profile configured to permit or otherwise allow routing of the cable 154 so that at least a portion of the cable 154 is retained in the cable housing 172 as the litter extension 36 moves between the retracted position 36R (see FIG. 5) and the extended position 36E (see FIG. 6).

In the illustrated version, the guide 176 defines a catch 238 extending out from the outer surface 236 configured to at least partially prevent the cable 154 from moving over the guide 176. It will be appreciated that various types, styles, arrangements, and/or quantities of catches 238 could be employed to limit movement of the cable 154 relative to the guide 176. In the illustrated version, a guide wall 240 having an outer surface 242 is formed extending in a downward direction from the lower wall 202. Here, the guide wall 240 extends tangentially relative to the outer surface 236 of the guide 176 towards the outlet 180 from the guide aperture 214.

Referring now to FIGS. 5-9, the cable 154 extends from the first end 156 at the user interface 37, through the inlet 178 of the cable housing 172, is supported by the guide 176 disposed within the inner cavity 174 of the cable housing 172, and extends out through the outlet 180 to the second end 158 towards the actuator 138. The cable housing 172 retains the retained portion 182 of the cable 154 between the inlet 178 and the outlet 180 as noted above. In some versions, the retained portion 182 of the cable 154 at least partially encircles the guide 176. In some versions, the cable 154 enters the inner cavity 174 of the cable housing 172 through the inlet 178, at least partially encircles the guide 176, routes through the guide aperture 214, follows the guide wall 240, through the outlet aperture 216, and through the outlet 180 to the second end 158 towards the actuator 138.

In some versions, the outlet 180 is positioned opposite the inner cavity 174 from the inlet 178 in the longitudinal direction. However, other configurations are contemplated, and the outlet 180 may be positioned opposite the guide 176 from the inlet 178 in the lateral, longitudinal, and/or other directions. The inlet 178 may be positioned at a distance closer to the user interface 37 than the outlet 180. In the illustrated version, the cable 154 includes a stop 244 to limit the movement of at least a portion of the cable 154 between the first end 156 and the second end 158 toward the guide 176. The stop 244 may include or otherwise be defined as a crimp element coupled to the cable 154 and arranged to engage with at least one of the inlet 178 or the outlet 180 of the cable housing 172. In some versions, the stop 244 is positioned between the first end 156 and inlet 178 and is arranged for abutment with the outward face 192 to limit movement of the cable 154 relative to the cable housing 172 in a first direction A. The cable may further include a second stop 246 positioned within the inner cavity 174 and arranged for abutment with the inner face 206 to limit movement of the cable 154 relative to the cable housing 172 in a second direction B opposite to the first direction A. In some versions, the stop 244 is positioned between the second end 158 and outlet 180 and is arranged for abutment with the outward face 192 to limit movement of the cable 154 relative to the cable housing 172 in the second direction B. In some versions, the second stop 246 is positioned within the inner cavity 174 and is arranged for abutment with the inner face 206 to limit movement of the cable 154 relative to the cable housing in the first direction A.

When the litter extension 36 is disposed in the retracted position 36R (see FIG. 5), the retained portion 182 of the cable 154 defines a first length L1. When the litter extension 36 is disposed in the extended position 36E (see FIG. 6), the retained portion 182 of the cable 154 defines a second length L2 smaller than the first length L1. As the litter extension 36 moves from the retracted position 36R into one of the one or more extended positions 36E, the length of the retained portion 182 decreases causing the retained portion 182 of the cable to move in a direction towards the guide 176. Here, the retained portion 182 may abut the outer surface 236 of the guide 176, and the catch 238 prevents the cable 154 from movement over the guide 176. However, it will be appreciated that other configurations are contemplated, and a different arrangement of one or more of the catch 238 and/or stops 244, 246 could be employed to facilitate allowing a length of the retained portion 182 to increase as the litter extension 36 moves from the retracted position 36R to the extended position 36E.

As noted above, in some versions the system S employs the loading and unloading system 53 to removably secure the patient transport apparatus 20 to the emergency response vehicle V. Referring now to FIGS. 10-12, the loading and unloading system 53 may be mounted in the cargo area C of the emergency vehicle V, and is configured to assist in the loading or unloading of the patient transport apparatus 20 into or out of emergency vehicle V by providing cantilevered support to the patient transport apparatus 20 either before the patient transport apparatus 20 is loaded into the emergency vehicle V or when the patient transport apparatus 20 is being unloaded. Here, once the litter 22 of the patient transport apparatus 20 is supported by the loading and unloading system 53, the lift mechanism 84 can be operated to raise the base 62 towards the litter 22 so as to allow the patient transport apparatus 20 to be loaded into the emergency vehicle V. The cantilevered support afforded by the loading and unloading system 53 transfers the weight of and on the patient transport apparatus 20 to the emergency vehicle V such that a caregiver need not provide any significant vertical support to the patient transport apparatus 20, and instead needs to only apply longitudinal force to guide by pushing or pulling the patient transport apparatus 20 into or out of the emergency vehicle V once it is supported by the loading and unloading system 53.

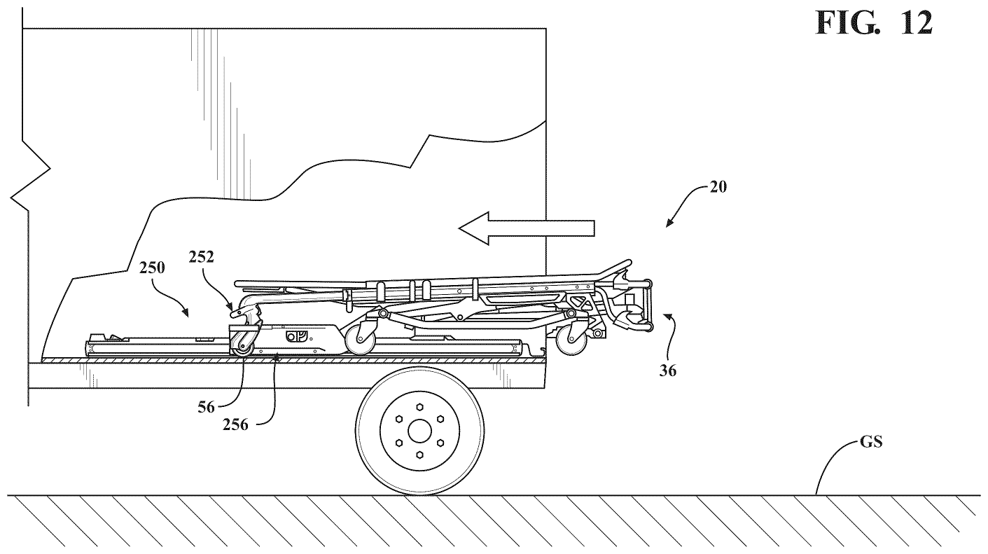

As is depicted in FIG. 10, the loading and unloading system 53 generally includes a support base 248, which is mounted in the cargo area C of the emergency vehicle V (e.g., an ambulance), and a transfer track 250 which is mounted on the base 62. The loading and unloading system 53 also includes a trolley 252, which is slidably mounted on the transfer track 250 for movement therewith along the base 62. To engage the patient transport apparatus 20, the trolley 252 includes a pair of cantilevered arms 254 and a trolley frame 256 to which the cantilevered arms 254 are mounted for pivotal movement between a released position 254R (see FIG. 10) and an engaged position 254E (see FIGS. 11-12).

The transfer track 250 and trolley 252 are configured to provide a nested rail arrangement to provide greater extension of the trolley 252 from the emergency vehicle V. During operation, the cantilevered arms 254 are pivoted between the released position 254R (see FIG. 10) and an engaged position 254E (see FIGS. 11-12) by a drive mechanism 258. Once the patient transport apparatus 20 has been loaded onto the trolley 252 and cantilevered arms 254 have been pivoted to the engaged position 254E (see FIG. 11) to support the patient transport apparatus 20, the lift mechanism 84 is used to move the base 62 towards the litter 22 (e.g., to a fully-lowered configuration), and the trolley 252 along with the patient transport apparatus 20 can be pushed longitudinally into the cargo area C of the emergency vehicle V with loading wheels 56 straddling the support base 248 into the received position depicted in FIG. 12.

When deployed in the engaged position 254E as depicted in FIG. 11, the cantilevered arms 254 extend into engagement with the head end of the litter 22 of the patient transport apparatus 20 in order to support the patient transport apparatus 20. Here, it will be appreciated that, because of how the cable 154 is routed towards the actuator 138 of the lift mechanism 84 from the litter extension 36, the cable housing 172 of the cable assembly 170 of the versions described herein helps ensure that slack in the cable 154 does not accumulate adjacent to areas which may be subject to external contact or binding, such as for example by the cantilevered arms 254 of the loading and unloading system 53. Moreover, the cable assembly 170 also helps ensure that the cable 154 is routed properly with minimal slack irrespective of which of the plurality of litter extension positions the litter extension 36 is disposed in. Put differently, the cable housing 172 routes the cable 154 with minimal slack when the litter extension 36 is in both the retracted position 36R and the extended position 36E. While the version of the cable assembly 170 illustrated throughout the drawings is directed towards routing Bowden style cables 154 employed to facilitate “manual” lowering operations of the actuator 138 of the lift mechanism 84 while optimizing slack and routing of the cable 154 to accommodate movement effected by the corresponding movement of the litter extension 36, those having ordinary skill in the art will appreciate that the cable assembly 170 could be utilized in other configurations of the patient transport apparatus where cables 154, wires, and the like need to be routed with minimal slack to accommodate relative movement between different components. By way of non-limiting example, similar cable assemblies 170 could be employed by the patient transport apparatus 20 to accommodate head end extension (e.g., for the loading wheels 56), movement of controls to adjust the back section 52 or other parts of the patient support deck 49, movement of controls used to operate wheels 80, and the like. Other configurations are contemplated.

It will be further appreciated that the terms “include,” “includes,” and “including” have the same meaning as the terms “comprise,” “comprises,” and “comprising.” Moreover, it will be appreciated that terms such as “first,” “second,” “third,” and the like are used herein to differentiate certain structural features and components for the non-limiting, illustrative purposes of clarity and consistency.

Several configurations have been discussed in the foregoing description. However, the configurations discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

The present disclosure also comprises the following clauses, with specific features laid out in dependent clauses, that may specifically be implemented as described in greater detail with reference to the configurations and drawings above.

### Clauses

I. A patient transport apparatus comprising:
a base;
a litter defining a patient support surface to support a patient;
a lift mechanism interposed between the base and the litter, the lift mechanism including an actuator for moving the litter relative to the base between a plurality of vertical configurations including a lowered configuration and a raised configuration;
a litter extension supported for movement relative to the patient support surface between a plurality of litter extension positions including a retracted position and one or more extended positions, the litter extension supporting a user interface for operating the actuator of the lift mechanism; and
a cable assembly including:
   a cable to translate mechanical force applied to the user interface to the actuator to release the lift mechanism for movement between the raised configuration and the lowered configuration, the cable extending between a first end coupled to the user interface and a second end coupled to the actuator of the lift mechanism, and
   a cable housing operatively attached to the litter, the cable housing defining an inner cavity and a guide disposed within the inner cavity and supporting the cable between the first end and the second end to retain at least a portion of the cable between the first end and the second end as the litter extension moves between the plurality of litter extension positions.

II. The patient transport apparatus according to clause I, wherein the cable defines a retained portion disposed within the inner cavity of the cable housing; and
wherein the retained portion has a first length in the retracted position and a second length in one of the one or more extended positions, the first length being larger than the second length.

III. The patient transport apparatus according to clause II, wherein the retained portion encircles the guide.

IV. The patient transport apparatus according to any of clauses I-III, wherein the cable housing comprises an upper portion, and a lower portion operatively attached to the upper portion.

V. The patient transport apparatus according to clause IV, wherein the lower portion includes a lower wall having at least one drain aperture to permit a flow of fluids out of the inner cavity.

VI. The patient transport apparatus according to clause V, wherein the lower wall includes a plurality of drain apertures; and
wherein the lower wall slopes downward to at least one of the plurality of drain apertures.

VII. The patient transport apparatus according to any of clauses I-VI, wherein the litter includes a frame with a pair of side rails; and
wherein the litter extension is telescopically affixed to the pair of side rails for movement between the plurality of litter extension positions.

VIII. The patient transport apparatus according to clause VII, wherein the litter extension is arranged adjacent to a foot end side of the frame.

IX. The patient transport apparatus according to any of clauses VII-VIII, wherein the cable housing is operatively attached to the frame.

X. The patient transport apparatus according to any of clauses VII-IX, wherein the litter further includes a cross rail extending between the pair of side rails.

XI. The patient transport apparatus according to clause X, wherein the cable housing includes a coupling mechanism extending in an outward direction relative to the inner cavity, the coupling mechanism operatively attached to the cross rail.

XII. The patient transport apparatus according to clause XI, wherein the cross rail is further defined as a first cross rail; and
wherein the litter further includes a second cross rail, spaced from the first cross rail, extending between the pair of side rails.

XIII. The patient transport apparatus according to clause XII, wherein the coupling mechanism is further defined as a first coupling mechanism operatively attached to the first cross rail; and
wherein the cable housing includes a second coupling mechanism, spaced from the first coupling mechanism, operatively attached to the second cross rail.

XIV. The patient transport apparatus according to any of clauses I-XIII, wherein the cable housing defines an inlet and an outlet.

XV. The patient transport apparatus according to clause XIV, wherein the outlet is positioned opposite the inner cavity from the inlet in a longitudinal direction.

XVI. The patient transport apparatus according to any of clauses XIV-XV, wherein the inlet is positioned at a distance closer to the user interface than the outlet.

XVII. The patient transport apparatus according to clause XVI, wherein the cable includes a stop to limit movement of a portion of the cable between the first end and the second end toward the guide.

XVIII. The patient transport apparatus according to clause XVII, wherein the stop includes a crimp element coupled to the cable and arranged to engage with at least one of the inlet or the outlet of the cable housing.

XIX. The patient transport apparatus according to clause XVIII, wherein the cable housing defines an outward face facing away from the inner cavity and an inner face facing towards the inner cavity.

XX. The patient transport apparatus according to clause XIX, wherein the stop is positioned between the first end and inlet and arranged for abutment with the outward face to limit movement of the cable relative to the cable housing in a first direction.

XXI. The patient transport apparatus according to clause XX, wherein the crimp element is further defined as a first crimp element, and further includes a second crimp element positioned within the inner cavity and arranged for abutment with the inner face to limit movement of the cable relative to the cable housing in a second direction.

XXII. The patient transport apparatus according to any of clauses XIX-XXI, wherein the stop is positioned between the second end and outlet and arranged for abutment with the outward face to limit movement of the cable relative to the cable housing in a second direction.

XXIII. The patient transport apparatus according to clause XXII, wherein the crimp element is further defined as a first crimp element, and further includes a second crimp element positioned within the inner cavity and arranged for abutment with the inner face to limit movement of the cable relative to the cable housing in a first direction.

XXIV. The patient transport apparatus according to any of clauses I-XXIII, wherein the user interface includes:
a manual release element coupled with the first end of the cable, and
a control panel in electrical communication with a controller for operating the actuator of the lift mechanism.

XXV. The patient transport apparatus according to clause XXIV, wherein the manual release element includes a lever arranged for pivoting movement in response to user engagement to move the cable and operate the actuator to move the litter relative to the base.

XXVI. A system for use in removably loading a patient transport apparatus into an emergency vehicle, the system comprising:
a loading and unloading system for attaching to the emergency vehicle, the loading and unloading system including:
   a track for mounting to the emergency vehicle, and
   a trolley slidably mounted to the tracks; and
a patient transport apparatus configured for releasable attachment to the loading and unloading system, the patient transport apparatus including:
   a base;
   a litter defining a patient support surface to support a patient;
   a lift mechanism interposed between the base and the litter, the lift mechanism including an actuator for moving the litter relative to the base between a plurality of vertical configurations including a lowered configuration and a raised configuration;
   a litter extension supported for movement relative to the patient support surface between a plurality of litter extension positions including a retracted position and one or more extended positions, the litter extension supporting a user interface for operating the actuator of the lift mechanism; and
   a cable assembly including:
      a cable to translate mechanical force applied to the user interface to the actuator to release the lift mechanism for movement between the raised configuration and the lowered configuration, the cable extending between a first end coupled to the user interface and a second end coupled to the actuator of the lift mechanism, and
      a cable housing operatively attached to the litter, the cable housing defining an inner cavity and a guide disposed within the inner cavity and supporting the cable between the first end and the second end to retain at least a portion of the cable between the first end and the second end as the litter extension moves between the plurality of litter extension positions.

XXVII. The system according to clause XXVI, wherein the trolley includes an arm moveable between an engaged position in which the arm is supporting the patient transport apparatus, and a released position in which the arm in not supporting the patient transport apparatus.

XXVIII. The system according to any of clauses XXVI-XXVII, wherein the cable defines a retained portion disposed within the inner cavity of the cable housing; and
wherein the retained portion has a first length in the retracted position and a second length in one of the one or more extended positions, the first length being larger than the second length.

XXIX. The system according to clause XXVIII, wherein the retained portion encircles the guide.

XXX. The system according to any of clauses XXVI-XXIX, wherein the cable housing comprises an upper portion, and a lower portion operatively attached to the upper portion.

XXXI. The system according to clause XXX, wherein the lower portion includes a lower wall having at least one drain aperture to permit a flow of fluids out of the inner cavity.

XXXII. The system according to clause XXXI, wherein the lower wall includes a plurality of drain apertures; and
wherein the lower wall slopes downward towards at least one of the plurality of drain apertures.

XXXIII. The system according to any of clauses XXVI-XXXII, wherein the litter includes a frame with a pair of side rails; and
wherein the litter extension is telescopically affixed to the pair of side rails for movement between the plurality of litter extension positions.

XXXIV. The system according to clause XXXIII, wherein the litter extension is arranged adjacent to a foot end side of the frame.

XXXV. The system according to any of clauses XXXIII-XXXIV, wherein the cable housing is operatively attached to the frame.

XXXVI. The system according to any of clauses XXXIII-XXXV, wherein the litter further includes a cross rail extending between the pair of side rails.

XXXVII. The system according to clause XXXVI, wherein the cable housing includes a coupling mechanism extending in an outward direction relative to the inner cavity, the coupling mechanism operatively attached to the cross rail.

XXXVIII. The system according to clause XXXVII, wherein the cross rail is further defined as a first cross rail; and
wherein the litter further includes a second cross rail, spaced from the first cross rail, extending between the pair of side rails.

XXXIX. The system according to clause XXXVIII, wherein the coupling mechanism is further defined as a first coupling mechanism operatively attached to the first cross rail; and
wherein the cable housing includes a second coupling mechanism, spaced from the first coupling mechanism, operatively attached to the second coupling mechanism.

XL. The system according to any of clauses XXVI-XXXIX, wherein the cable housing defines an inlet and an outlet.

XLI. The system according to clause XL, wherein the outlet is positioned opposite the inner cavity from the inlet in a longitudinal direction.

XLII. The system according to any of clauses XL-XLI, wherein the inlet is positioned at a distance closer to the user interface than the outlet.

XLIII. The system according to clause XLII, wherein the cable includes a stop to limit movement of a portion of the cable between the first end and the second end toward the guide.

XLIV. The system according to clause XLIII, wherein the stop includes a crimp element coupled to the cable and arranged to engage with at least one of the inlet or the outlet of the cable housing.

XLV. The system according to clause XLIV, wherein the cable housing defines an outward face facing away from the inner cavity and an inner face facing towards the inner cavity.

XLVI. The system according to clause XLV, wherein the stop is positioned between the first end and inlet and arranged for abutment with the outward face to limit movement of the cable relative to the cable housing in a first direction.

XLVII. The system according to clause XLVI, wherein the crimp element is further defined as a first crimp element, and further includes a second crimp element positioned within the inner cavity and arranged for abutment with the inner face to limit movement of the cable relative to the cable housing in a second direction.

XLVIII. The system according to any of clauses XLV-XLVII, wherein the stop is positioned between the second end and outlet and arranged for abutment with the outward face to limit movement of the cable relative to the cable housing in a second direction.

XLIX. The system according to clause XLVIII, wherein the crimp element is further defined as a first crimp element, and further includes a second crimp element positioned within the inner cavity and arranged for abutment with the inner face to limit movement of the cable relative to the cable housing in a first direction.

L. The system according to any of clauses XXVI-XLIX, wherein the user interface includes:
a manual release element coupled with the first end of the cable; and
a control panel in electrical communication with a controller for operating the actuator of the lift mechanism.

LI. The system according to clause L, wherein the manual release element includes a lever arranged for pivoting movement in response to user engagement to move the cable and operate the actuator to move the litter relative to the base.

What is claimed is:

1. A patient transport apparatus comprising:
a base;
a litter defining a patient support surface to support a patient;
a lift mechanism interposed between the base and the litter, the lift mechanism including an actuator for moving the litter relative to the base between a plurality of vertical configurations including a lowered configuration and a raised configuration;
a litter extension supported for movement relative to the patient support surface between a plurality of litter extension positions including a retracted position and one or more extended positions, the litter extension supporting a user interface for operating the actuator of the lift mechanism; and
a cable assembly including:
a cable to translate mechanical force applied to the user interface to the actuator to release the lift mechanism for movement between the raised configuration and the lowered configuration, the cable extending between a first end coupled to the user interface and a second end coupled to the actuator of the lift mechanism, and
a cable housing operatively attached to the litter, the cable housing defining an inner cavity and a guide disposed within the inner cavity and supporting the cable between the first end and the second end to retain at least a portion of the cable between the first end and the second end as the litter extension moves between the plurality of litter extension positions.

2. The patient transport apparatus according to claim 1, wherein the cable defines a retained portion disposed within the inner cavity of the cable housing; and
wherein the retained portion has a first length in the retracted position and a second length in one of the one or more extended positions, the first length being larger than the second length.

3. The patient transport apparatus according to claim 2, wherein the retained portion encircles the guide.

4. The patient transport apparatus according to claim 1, wherein the cable housing comprises an upper portion, and a lower portion operatively attached to the upper portion.

5. The patient transport apparatus according to claim 4, wherein the lower portion includes a lower wall having at least one drain aperture to permit a flow of fluids out of the inner cavity.

6. The patient transport apparatus according to claim 5, wherein the lower wall includes a plurality of drain apertures; and
wherein the lower wall slopes downward to at least one of the plurality of drain apertures.

7. The patient transport apparatus according to claim 1, wherein the litter includes a frame with a pair of side rails; and
wherein the litter extension is telescopically affixed to the pair of side rails for movement between the plurality of litter extension positions.

8. The patient transport apparatus according to claim 7, wherein the litter extension is arranged adjacent to a foot end side of the frame.

9. The patient transport apparatus according to claim 7, wherein the cable housing is operatively attached to the frame.

10. The patient transport apparatus according to claim 7, wherein the litter further includes a cross rail extending between the pair of side rails.

11. The patient transport apparatus according to claim 10, wherein the cable housing includes a coupling mechanism extending in an outward direction relative to the inner cavity, the coupling mechanism operatively attached to the cross rail.

12. The patient transport apparatus according to claim 11, wherein the cross rail is further defined as a first cross rail;
wherein the litter further includes a second cross rail, spaced from the first cross rail, extending between the pair of side rails;
wherein the coupling mechanism is further defined as a first coupling mechanism operatively attached to the first cross rail; and
wherein the cable housing includes a second coupling mechanism, spaced from the first coupling mechanism, operatively attached to the second cross rail.

13. The patient transport apparatus according to claim 1, wherein the cable housing defines an inlet and an outlet.

14. The patient transport apparatus according to claim 13, wherein the outlet is positioned opposite the inner cavity from the inlet in a longitudinal direction.

15. The patient transport apparatus according to claim 13, wherein the inlet is positioned at a distance closer to the user interface than the outlet.

16. The patient transport apparatus according to claim 15, wherein the cable includes a stop to limit movement of a portion of the cable between the first end and the second end toward the guide.

17. The patient transport apparatus according to claim 16, wherein the stop includes a crimp element coupled to the cable and arranged to engage with at least one of the inlet or the outlet of the cable housing.

18. The patient transport apparatus according to claim 17, wherein the cable housing defines an outward face facing away from the inner cavity and an inner face facing towards the inner cavity;
wherein the stop is positioned between the first end and inlet and arranged for abutment with the outward face to limit movement of the cable relative to the cable housing in a first direction; and
wherein the crimp element is further defined as a first crimp element, and further includes a second crimp element positioned within the inner cavity and arranged for abutment with the inner face to limit movement of the cable relative to the cable housing in a second direction.

19. The patient transport apparatus according to claim 17, wherein the cable housing defines an outward face facing away from the inner cavity and an inner face facing towards the inner cavity;
wherein the stop is positioned between the second end and outlet and arranged for abutment with the outward face to limit movement of the cable relative to the cable housing in a second direction; and
wherein the crimp element is further defined as a first crimp element, and further includes a second crimp element positioned within the inner cavity and arranged for abutment with the inner face to limit movement of the cable relative to the cable housing in a first direction.

20. The patient transport apparatus according to claim 1, wherein the user interface includes:
a manual release element coupled with the first end of the cable and having a lever arranged for pivoting movement in response to user engagement to move the cable and operate the actuator to move the litter relative to the base, and
a control panel in electrical communication with a controller for operating the actuator of the lift mechanism.
